(19) United States
(12) Patent Application Publication
(10) Pub. No.: US 2024/0280736 A1
(43) Pub. Date: Aug. 22, 2024

(54) OPTICAL FILTER SYSTEM AND METHOD

(71) Applicant: Hubei jiexun Photo-Electric Co., Ltd., Wuhan (CN)

(72) Inventors: Zhenhai XIE, Wuhan (CN); Chi CHENG, Wuhan (CN)

(73) Assignee: Hubei jiexun Photo-Electric Co., Ltd., Wuhan (CN)

(21) Appl. No.: 17/464,253

(22) PCT Filed: Apr. 27, 2020
(86) PCT No.: PCT/CN2020/087273

§ 371 Date: Sep. 1, 2023

(30) Foreign Application Priority Data
Mar. 4, 2019 (CN) 201910161624.4

(51) Int. Cl. G02B 5/26; G02B 27/09; G02B 27/30

(52) U.S. Cl. CPC G02B 5/26; G02B 27/0944; G02B 27/30

(57) ABSTRACT

An optical filter system is provided. The system includes a first collimator, a second collimator, and a reflective optical filter. An optical signal is inputted through a first port of the first collimator, is outputted through a second port of the first collimator, is filtered by the reflective optical filter, the filtered optical signal is inputted through second port of the first collimator and outputted through first port of the first collimator. The optical signal is inputted through a first port of the second collimator, is outputted through a second port of the second collimator, is filtered by the reflective optical filter, the filtered optical signal is inputted through the second port of the second collimator and outputted through the first port of the second collimator. The optical signal outputted through the first port of the first collimator is inputted to the first port of the second collimator.

The disclosure claims the priority of a Chinese Patent Application No. 201910161624.4 filed before China National Intellectual Property Administration on Mar. 4, 2019, entitled “OPTICAL FILTER SYSTEM AND METHOD”, which is incorporated herein by reference in its entirety.

### TECHNICAL FIELD

The disclosure relates to the field of optics, and in particular to, an optical filter system and method.

### BACKGROUND

An optical filter is an instrument configured to select a wavelength, and can select the desired wavelength from a large number of wavelengths, and light with other than this wavelength will be rejected. It can be used for wavelength selection, noise filtering of optical amplifiers, gain equalization, or optical multiplexing/demultiplexing. An optical fiber filter is an optical device that uses a special optical fiber structure to select or filter out light waves with specific wavelengths from light waves with different wavelengths. The optical fiber filter play an important role in dense wavelength division multiplexing fiber optic communications, frequency division multiplexing fiber optic communications, spectrum testing, fiber optic sensors and applications of fiber amplifier. There are many types of optical fiber filters, which can be roughly divided into a low-pass filter, a band-pass filter, a high-pass filter, a comb filter and the like based on output spectrum; can be roughly divided into a coherent filter such as etalon filter, a splitting filter such as grating filter, coating filter and the like based on principle. In the prior art optical filter, due to factors such as difficulty in aberration correction, some of wavelength properties are severely degraded after single filtration, the overall output spectrum quality is low, and some parameters such as bandwidth and optical signal-to-noise ratio cannot meet the requirements for application.

Therefore, the present disclosure proposes an optical filter system and method, which solves the problem that some of wavelength properties are severely degraded after single filtration, the overall output spectrum quality is low, and some parameters such as bandwidth and optical signal-to-noise ratio cannot meet requirements for application in the prior art, and has advantages that can achieve twice or multiple filtrations of the incident light, so that the bandwidth of the filtered spectrum and the optical signal-to-noise ratio can be improved.

### SUMMARY

The disclosure provides an optical filter system, which solves the problems of severe degradation of some wavelength properties after single filtration, low quality of overall output spectrum, and some parameters such as bandwidth and optical signal-to-noise ratio not meeting requirements for application in the prior art.

An embodiment of the disclosure provides an optical filter system comprising a first collimator, a second collimator and a reflective optical filter.

An optical signal is inputted through a first port of the first collimator and outputted through a second port of the first collimator, is filtered by the reflective optical filter, thereafter, the filtered optical signal is inputted through the second port of the first collimator and outputted through the first port of the first collimator.

An optical signal is inputted through a first port of the second collimator and outputted through a second port of the second collimator, is filtered by the reflective optical filter, thereafter, the filtered optical signal is inputted through the second port of the second collimator and outputted through the first port of the second collimator.

The optical signal outputted through the first port of the first collimator is inputted to the first port of the second collimator.

Preferably, the optical filter system further comprises a four-port circulator.

A first port of the circulator is configured to receive an optical signal.

A second port of the circulator is connected to the first port of the first collimator, and is configured to input the optical signal received by the first port of the circulator to the first port of the first collimator and receive the optical signal outputted from the first port of the first collimator.

A third port of the circulator is connected to the first port of the second collimator, and is configured to input the optical signal inputted to the second port of the circulator to the first port of the second collimator and receive the optical signal outputted from the first port of the second collimator.

A fourth port of the circulator is configured to output the optical signal inputted to the third port of the circulator.

An embodiment of the disclosure further provides an optical filter system comprising a first collimator, a second collimator and a reflective optical filter.

An optical signal is inputted through a first port of the first collimator and outputted through a second port of the first collimator, is filtered by the reflective optical filter, thereafter, the filtered optical signal is inputted through a second port of the second collimator and outputted through a first port of the second collimator.

An optical signal is inputted through the first port of the second collimator and outputted through the second port of the second collimator, is filtered by the reflective optical filter, thereafter, the filtered optical signal is inputted through the second port of the first collimator and outputted through the first port of the first collimator.

The optical signal outputted through the first port of the second collimator is inputted to the first port of the second collimator.

Preferably, the optical filter system further comprises a three-port circulator.

A first port of the circulator is configured to receive an optical signal.

A second port of the circulator is connected to the first port of the first collimator, and is configured to input the optical signal received by the first port of the circulator to the first port of the first collimator and to receive the optical signal outputted by the first port of the first collimator.

A third port of the circulator is configured to output the optical signal inputted to the second port of the circulator.

An embodiment of the disclosure further provides an optical filter system comprising a first collimator, a second collimator, a third collimator and a reflective optical filter.

An optical signal is inputted through a first port of the first collimator and outputted through a second port of the first collimator, is filtered by the reflective optical filter, thereafter the filtered optical signal passes through the third collimator, is filtered by the reflective optical filter, and then is inputted through a second port the second collimator and outputted through a first port of the second collimator.

Preferably, the third collimator comprises one collimator or multiple collimators connected in series.

An embodiment of the disclosure further provides an optical filter method, comprising the following steps:
inputting an optical signal subjected to collimation to a reflective optical filter and performing the collimation processing again after filtration and reflection;
performing the above steps at least twice.

Preferably, in the optical filter method, the optical signal is inputted through a first port of a first collimator and outputted through a second port of the first collimator, and then is filtered by the reflective optical filter, thereafter, the filtered optical signal is inputted through the second port of the first collimator and outputted through the first port of the first collimator; the optical signal outputted through the first port of the first collimator is inputted to a first port of a second collimator; the optical signal is inputted through the first port of the second collimator and outputted through the second port of the second collimator, is filtered by the reflective optical filter, thereafter, the filtered optical signal is inputted through the second port of the second collimator and outputted through the first port of the second collimator.

Preferably, a four-port circulator is used in the optical filter method; a first port of the circulator is configured to receive an optical signal; a second port of the circulator is connected to the first port of the first collimator, and is configured to input the optical signal received by the first port of the circulator to the first collimator and receive the optical signal outputted from the first collimator; a third port of the circulator is connected to the first port of the second collimator, and is configured to input the optical signal inputted to the second port of the circulator to the second collimator and receive the optical signal outputted from the second collimator; a fourth port of the circulator is configured to output the optical signal inputted to the third port of the circulator.

Preferably, in the optical filter method, the optical signal is inputted through a first port of a first collimator and outputted through a second port of the first collimator, is filtered by the reflective optical filter, thereafter, the filtered optical signal is inputted through a second port of a second collimator and outputted through a first port of the second collimator; the optical signal outputted through the first port of the second collimator is then inputted to the first port of the second collimator; the optical signal is inputted through the first port of the second collimator and outputted through the second port of the second collimator, is filtered by the reflective optical filter, thereafter, the filtered optical signal is inputted through the second port of the first collimator and outputted through the first port of the first collimator.

Preferably, a three-port circulator is used in the optical filter method; a first port of the circulator is configured to receive an optical signal; a second port of the circulator is connected to the first port of the first collimator, and is configured to input the optical signal received by the first port of the circulator to the first port of the first collimator and to receive the optical signal outputted by the first port of the first collimator; a third port of the circulator is configured to output the optical signal inputted to the second port of the circulator.

Preferably, in the optical filter method, the optical signal is inputted through the first port of the first collimator and outputted through the second port of the first collimator, is filtered by the reflective optical filter, thereafter the filtered optical signal passing through a third collimator, then filtered by the reflective optical filter again, and then is inputted through the second port of the second collimator and outputted through the first port of the second collimator.

Preferably, in the optical filter method, the third collimator comprises one collimator or multiple collimators connected in series.

Preferably, in the optical filter method, the first collimator, the second collimator and the third collimator are integrated into a multi-fiber collimator having M*N parallel optical fibers, with M and N being integers greater than or equal to 2.

Preferably, in the optical filter method, the reflective optical filter comprises a tunable reflection device, a beam expander, a diffraction grating and a mirror device; the optical signal entered the tunable reflection device is reflected by the tunable reflection device to the beam expander for beam expansion, is inputted into the diffraction grating for diffraction, and is finally reflected by the mirror device; the diffraction grating is a transmission diffraction grating which is configured to deflect different wavelengths of the transmitted optical signal at different angles, and then a part of the wavelength spectrum is reflected back along an input path through the mirror device.

The foregoing at least one technical solution adopted in the embodiments of the present disclosure can achieve the following beneficial effects:

The optical filter system and method have the advantages of being able to achieve twice or multiple filtrations of incident light, so that the bandwidth of the filtered spectrum, optical signal-to-noise ratio and the other properties of the filtered spectrum are improved.

### BRIEF DESCRIPTION OF THE DRAWINGS

The drawings described herein are provided for further understanding the disclosure and as a part of the disclosure. The exemplary embodiments of the disclosure and description thereof are used to explain the disclosure and not as any improper limitation to the disclosure. In the drawings:

FIG. 1 is a structural diagram of an optical filter system comprising a four-port circulator provided by an embodiment of the disclosure;

FIG. 2 is a structural diagram of an optical filter system comprising a three-port circulator provided by an embodiment of the disclosure;

FIG. 3 is a structural diagram of an optical filter system comprising a third collimator provided by an embodiment of the disclosure;

FIG. 4 is a flowchart of an optical filter method provided by an embodiment of the disclosure;

FIG. 5 is a schematic cross-sectional diagram of a 2*3 fiber core pigtail;

FIG. 6 is a schematic cross-sectional diagram of a 3*3 fiber core pigtail.

### DETAILED DESCRIPTION

In order to make the purposes, technical solutions and advantages of the disclosure clearer, the technical solutions of the disclosure will be clearly and completely described below with reference to the specific embodiments and the corresponding drawings. It is apparent that the described embodiments are merely part of the embodiments of the disclosure rather than all the embodiments. Based on the embodiments in the disclosure, all the other embodiments obtained by a person skilled in the art without paying creative work will fall into the protection scope of the disclosure.

Technical solutions provided by embodiments of the present disclosure will be described in detail below with reference to the accompanying drawings.

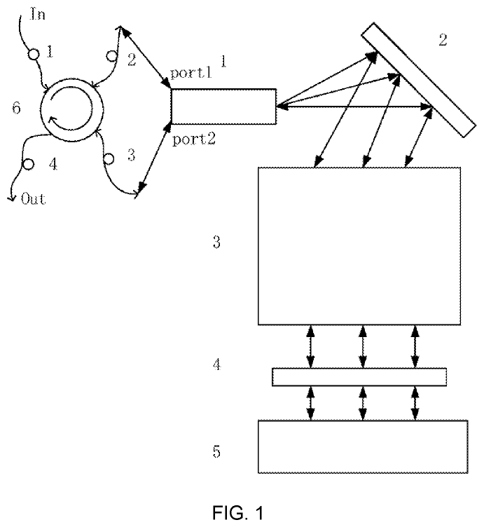

FIG. 1 is a structural diagram of an optical filter system comprising a four-port circulator provided by an embodiment of the disclosure. The optical filter system comprises a first collimator, a second collimator, and a reflective optical filter.

An optical signal is inputted through a first port (port 1) and outputted through a second port of the first collimator, is filtered by the reflective optical filter, thereafter, the filtered optical signal is inputted through the second port and outputted through the first port. An optical signal is inputted through a first port (port 2) and outputted through a second port of the second collimator, is filtered by the reflective optical filter, thereafter, the filtered optical signal is inputted through the second port and outputted through the first port. The optical signal outputted through the first port of the first collimator is inputted to the first port of the second collimator.

As an embodiment of the present disclosure, the first collimator and the second collimator may be integrated into a dual-fiber collimator 1 comprising two parallel optical fibers. The reflective optical filter comprises a tunable reflection device 2, a beam expander 3, a diffraction grating 4, and a mirror device 5. The tunable reflection device may be, for example, a 1-D MEMS mirror or other flat mirrors for reflecting optical signal. The beam expander may be, for example, a device for expanding the beam of an optical signal, such as a prism or a lens. The diffraction grating is a transmission diffraction grating, which is configured to deflect different wavelengths of the transmitted optical signal at different angles. Then a very small part of the wavelength spectrum is reflected back along an input path through a mirror device, thereby achieving the purpose of filtration.

When the optical filter system is in operation, an optical signal is inputted through a first port and outputted through a second port of the first collimator, is entered the tunable reflection device, and is reflected by the tunable reflection device to the beam expander to expand the beam, and inputted into the diffraction grating for diffraction, and finally the optical signal is reflected to the second port of the first collimator by the mirror device, and is outputted by the first port of the first collimator. The optical signal outputted from the first port of the first collimator is inputted to a first port of the second collimator, and then outputted through a second port of the second collimator, is entered the tunable reflection device, is reflected by the tunable reflection device to the beam expander to expand the beam, and inputted into the diffraction grating for diffraction, and finally the optical signal is reflected to the second port of the second collimator by the mirror device, and is outputted by the first port of the second collimator.

As an implementation of the embodiment of the present disclosure, the optical filter system further comprises a four-port circulator 6.

A first port of the circulator is configured to receive an optical signal. A second port of the circulator is connected to the first port of the first collimator, and is configured to input the optical signal received by the first port of the circulator to the first port of the first collimator, and receive the optical signal outputted by the first port of the first collimator. A third port of the circulator is connected to the first port of the second collimator, and is configured to input the optical signal inputted to the second port of the circulator to the first port of the second collimator, and receive the optical signal outputted from the first port of the second collimator. A fourth port of the circulator is configured to output the optical signal inputted to the third port.

When the optical filter system is in operation, the optical signal enters the circulator through the first port of the circulator, and is inputted to the first port of the first collimator through the second port of the circulator, and is inputted to the tunable reflection device through the second port of the first collimator, is reflected by the tunable reflection device to the beam expander for beam expansion, is inputted into the diffraction grating for diffraction, and the optical signal is finally reflected by the mirror device to the second port of the first collimator, is then inputted to the second port of the circulator from the first port of the first collimator. After entering the circulator, the optical signal is inputted to the first port of the second collimator through the third port of the circulator, is then outputted to the tunable reflection device through the second port of the second collimator, is reflected by the tunable reflection device to the beam expander for beam expansion, is inputted into the diffraction grating for diffraction, and the optical signal is finally reflected by the mirror device to the second port of the second collimator, is outputted from the first port of the second collimator and enters the third port of the circulator. After entering the circulator, the optical signal is outputted through a fourth port of the circulator.

In this embodiment, the optical filter system may filter the optical signal twice. Further, the optical filter system can achieve multiple filtrations of the optical signal by increasing the number of collimators and of the ports of the circulator connected to the first port of the collimator.

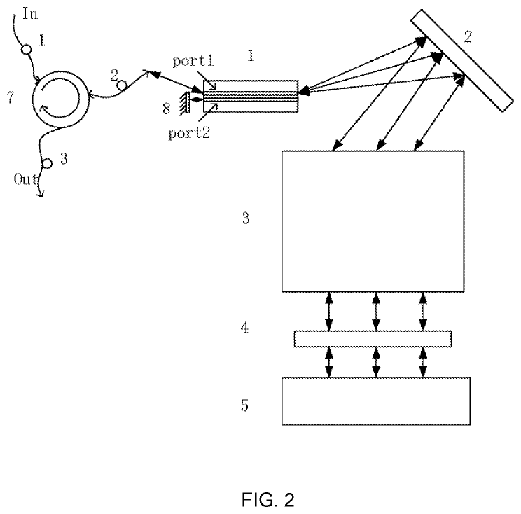

FIG. 2 is a structural diagram of an optical filter system comprising a three-port circulator provided by an embodiment of the disclosure. The optical filter system comprises a first collimator, a second collimator, and a reflective optical filter.

An optical signal is inputted through a first port (port 1) of the first collimator and outputted through a second port of the first collimator, is filtered by the reflective optical filter, thereafter, the filtered optical signal is inputted through a second port of the second collimator and outputted through a first port (port 2) of the second collimator. The optical signal is inputted through the first port of the second collimator and outputted through the second port of the second collimator, is filtered by the reflective optical filter, thereafter, the filtered optical signal is inputted through the second port of the first collimator and outputted through the first port of the first collimator. The optical signal outputted through the first port of the second collimator is then inputted to the first port of the second collimator.

As an embodiment of the present disclosure, the first collimator and the second collimator may be integrated into a dual-fiber collimator 1 comprising two parallel optical fibers, and the reflective optical filter comprises a tunable reflection device 2, a beam expander 3, a diffraction grating 4 and a mirror device 5. The tunable reflection device may be, for example, a 1-D MEMS mirror or other flat mirrors for reflecting optical signal. The beam expander may be, for example, a device for expanding the beam of an optical signal, such as a prism or a lens. The diffraction grating is a transmission diffraction grating which is configured to deflect different wavelengths of the transmitted optical signal at different angles. Then a very small part of the wavelength spectrum is reflected back along an input path through a mirror device to achieve the purpose of filtration.

When the optical filter system is in operation, the optical signal is inputted through the first port of the first collimator and outputted from the second port of the first collimator, enters the tunable reflection device, and the optical signal is then reflected by the tunable reflection device to the beam expander for beam expansion by adjusting the angle of the tunable reflection device, is inputted to the diffraction grating for diffraction, and the optical signal is finally reflected by the mirror device to the second port of the second collimator, outputted from the first port of the second collimator. The optical signal outputted from the first port of the second collimator is then inputted to the first port of the second collimator, and then outputted from the second port of the second collimator, enters the tunable reflection device, and is reflected by the tunable reflection device to the beam expander for beam expansion, then is inputted into the diffraction grating for diffraction, and the optical signal is finally reflected by the mirror device to the second port of the first collimator, and outputted from the first port of the first collimator.

In this embodiment, the optical signal outputted by the first port of the second collimators can be inputted to the first port of the second collimator again by setting a mirror 8 at the first port of the second collimator.

As an implementation of the embodiment of the present disclosure, the optical filter system further comprises a three-port circulator 7.

A first port of the circulator is configured to receive an optical signal. The second port of the circulator is connected to the first port of the first collimator, and is configured to input the optical signal received from the first port of the circulator to the first port of the first collimator and receive the optical signal outputted by the first port of the first collimator. The third port of the circulator is configured to output the optical signal inputted to the second port of the circulator.

When the optical filter system is in operation, an optical signal is inputted to the circulator through the first port of the circulator, and is inputted to the first port of the first collimator through the second port of the circulator, and then outputted from the second port of the first collimator to enter the tunable reflection device, then the optical signal is reflected by the tunable reflection device to the beam expander for beam expansion by adjusting the angle of the tunable reflection device, and is inputted to the diffraction grating for diffraction, and the optical signal is finally reflected by the mirror device to the second port of the second collimator, and is outputted from the first port of the second collimator. The optical signal is inputted to the first port of the second collimator again through the mirror and then outputted from the second port of the second collimator, then enters the tunable reflection device, and is reflected by the tunable reflection device to the expansion device for beam expansion, is inputted to the diffraction grating for diffraction, and the optical signal is finally reflected by the mirror device to the second port of the first collimator, is inputted to the second port of the circulator through the first port of the first collimator. After entering the circulator, the optical signal is outputted through a third port of the circulator.

In this embodiment, the optical filter system can filter the optical signal twice. Further, the optical filter system can achieve multiple filtrations of the optical signal by increasing the number of collimators and of the circulator ports connected to the first port of the collimator.

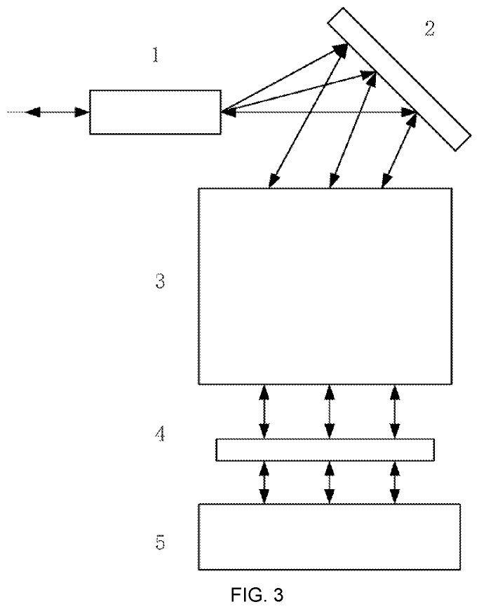

FIG. 3 is a structural diagram of an optical filter system comprising a third collimator provided by an embodiment of the disclosure. The optical filter system comprises a first collimator, a second collimator, a third collimator, and a reflective optical filter.

The optical signal is inputted through the first port of the first collimator and outputted through the second port of the first collimator, is filtered by the reflective optical filter, thereafter the filtered optical signal passes through the third collimator, is filtered by the reflective optical filter again, and then is inputted through the second port of the second collimator and outputted through the first port of the second collimator.

As an embodiment of the present disclosure, the third collimator comprises one collimator or multiple collimators connected in series, for example, the third collimator may be a collimator having two collimators with their first ports connected together. The first collimator, the second collimator and the third collimator may be integrated into a four-fiber collimator 1 comprising four parallel optical fibers, and the first ports of two optical fibers in the four-fiber collimator are connected together. The reflective optical filter comprises a tunable reflection device 2, a beam expander 3, a diffraction grating 4, and a mirror device 5. The tunable reflection device may be, for example, a 1-D MEMS mirror or other flat mirrors for reflecting optical signal. The beam expander may be, for example, a device for expanding the beam of an optical signal, such as a prism or a lens. The diffraction grating is a transmission diffraction grating which is configured to deflect different wavelengths of the transmitted optical signal at different angles. Then a very small part of the wavelength spectrum is reflected back along an input path through a mirror device to achieve the purpose of filtration.

When the optical filter system is in operation, the optical signal is inputted through the first port of the first collimator and outputted through the second port of the first collimator, enters the tunable reflection device, and is reflected by the tunable reflection device to the beam expander device for beam expansion, is inputted to the diffraction grating for diffraction, and the optical signal is finally reflected by the mirror device to the second port of the third collimator, and outputted from the first port of the third collimator. The shape of the third collimator is U-shaped. The optical signal enters the tunable reflection device after outputted through the first port of the third collimator, and is inputted to the diffraction grating for diffraction after being reflected by the tunable reflection device to the beam expander for beam expansion, and the optical signal is finally reflected by the mirror device to the second port of the second collimator, and outputted through the first port of the second collimator.

In this embodiment, the optical filter system may filter the optical signal twice. Further, the optical filter system may achieve multiple filtrations of the optical signal by increasing the number of collimators.

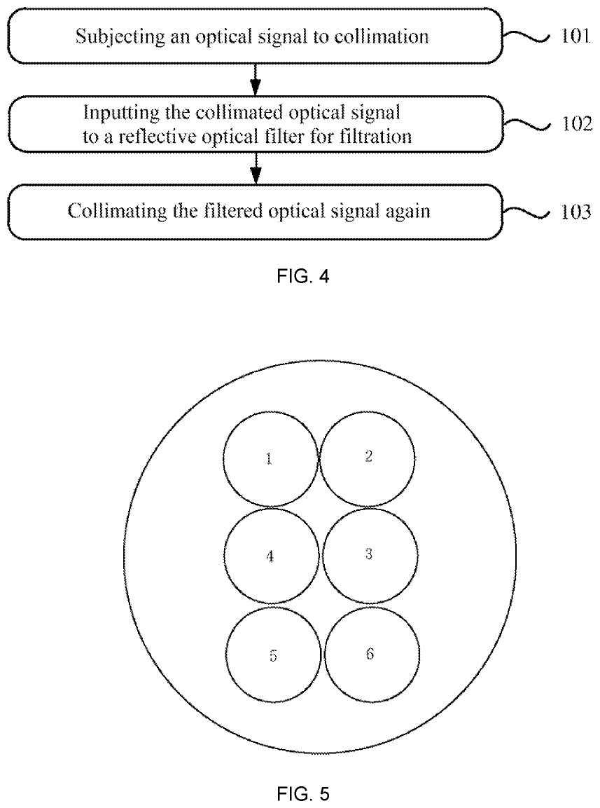

FIG. 4 is a flowchart of an optical filter method provided by an embodiment of the disclosure, comprising the following steps:

Step 101: subjecting an optical signal to collimation.

In step 101, the optical signal is inputted to the first port of the first collimator in the above optical fiber filter system for collimation, and the optical signal is outputted from the first port of the first collimator after being converted into parallel light.

Step 102: inputting the collimated optical signal to a reflective optical filter for filtration.

In step 102, the optical signal collimated by the first collimator is inputted to the reflective optical filter through the second port of the first collimator for filtration.

Preferably, the reflective optical filter comprises a tunable reflection device, a beam expander, diffraction grating and a mirror device. The tunable reflection device may be, for example, a 1-D MEMS mirror or other flat mirrors for reflecting optical signal. The beam expander may be, for example, a device for expanding the beam of an optical signal, such as a prism or a lens. The diffraction grating is a transmission diffraction grating, which is configured to deflect different wavelengths of the transmitted optical signal at different angles. Then a very small part of the wavelength spectrum is reflected back along an input path through a mirror device to achieve the purpose of filtration.

Specifically, the optical signal enters the tunable reflection device, then is inputted into the diffraction grating for diffraction after being reflected by the tunable reflection device to the beam expander for beam expansion, and the optical signal is finally reflected by the mirror device. In different optical filter systems, the filtered optical signal may be reflected to the second port of the first collimator/second collimator/third collimator by tuning the tunable reflection device.

Step 103: collimating the filtered optical signal again.

In step 103, in different systems, the filtered optical signal received by the second port of the first collimator/second collimator/third collimator is outputted from its the first port after being collimated.

The above steps 101˜103 are performed repeatedly at least twice.

In different systems, when the filtered optical signal is inputted to the second port of the first collimator, the filtered optical signal outputted from the first port of the first collimator is inputted to the first port of the second collimator for collimation, is then inputted to the reflective optical filter through the second port of the second collimator for filtration, then is inputted to the second port of the second collimator, and outputted through the first port of the second collimator.

When the filtered optical signal is inputted to the second port of the second collimator, the filtered optical signal outputted from the first port of the second collimator is inputted to the first port of the second collimator for collimation, is then inputted to the reflective optical filter for filtration through the second port of the second collimator, and is then inputted the second port of the first collimator, and outputted through the first port of the first collimator.

When the filtered optical signal is inputted to the second port of the third collimator, the shape of the third collimator being U-shaped, and the filtered optical signal is collimated by the third collimator, and is then directly inputted to the reflective optical filter for filtration through the first port of the third collimator, and is then inputted to the second port of the second collimator, and outputted through the first port of the second collimator

The first collimator and the second collimator may be integrated into a dual-fiber collimator comprising two parallel optical fibers. The first collimator, the second collimator and the third collimator may be integrated into a four-fiber collimator comprising four parallel optical fibers, and the first ports of two optical fibers in the four-fiber collimator are connected together.

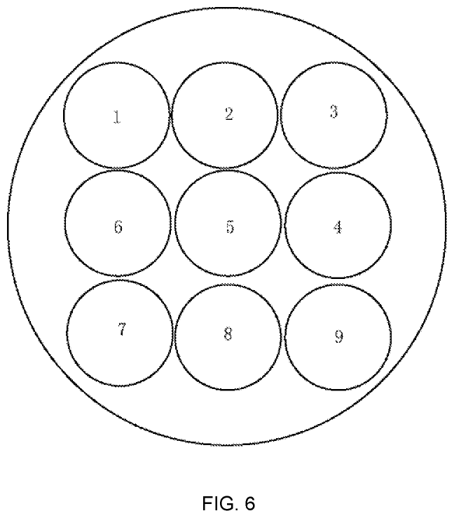

Further, the first collimator, the second collimator and the third collimator may be integrated into a multi-fiber collimator containing M*N parallel optical fibers, M and N are integers greater than or equal to 2. The third collimator comprises one collimator or multiple collimators connected in series. For example, FIG. 5 is a schematic cross-sectional diagram of an integrated multi-fiber collimator with M*N parallel optical fibers provided by an embodiment of the disclosure, with M=2 and N=3. FIG. 6 is a schematic cross-sectional diagram of an integrated multi-fiber collimator with M*N parallel optical fibers provided by an embodiment of the disclosure, with M=3 and N=3.

A person skilled in the art should understand that the terms “include”, “comprise” or any other variations thereof are intended to cover non-exclusive inclusions, such that processes, methods, products or devices that include a series of elements include not only those elements but also include other elements that are not explicitly listed, or further include elements that are inherent to such processes, methods, products or devices. In the case of no more limitation, the element defined by the sentence “comprises a . . . ” does not exclude the existence of other identical elements in the processes, methods, products or devices comprising such element.

The above description is only embodiments of the disclosure and is not intended to limit the disclosure. For a person skilled in the art, the disclosure may have various changes and variations. Any modification, equivalent replacement or improvement made within the spirit and principle of the disclosure should fall in the scope of the claims of the disclosure.

What is claimed is:

1. An optical filter system, comprising a first collimator, a second collimator and a reflective optical filter;
an optical signal being inputted through a first port of the first collimator and outputted through a second port of the first collimator, and then being filtered by the reflective optical filter, thereafter, the filtered optical signal being inputted through the second port of the first collimator and outputted through the first port of the first collimator;
an optical signal being inputted through a first port of the second collimator and outputted through a second port of the second collimator, and then being filtered by the reflective optical filter, thereafter, the filtered optical signal being inputted through the second port of the second collimator and outputted through the first port of the second collimator;
the optical signal outputted through the first port of the first collimator being inputted to the first port of the second collimator.

2. The optical filter system of claim 1, wherein the optical filter system further comprises a four-port circulator;
a first port of the circulator is configured to receive an optical signal;
a second port of the circulator is connected to the first port of the first collimator, and is configured to input the optical signal received by the first port of the circulator to the first collimator and receive the optical signal outputted from the first collimator;
a third port of the circulator is connected to the first port of the second collimator, and is configured to input the optical signal inputted to the second port of the circulator to the second collimator and receive the optical signal outputted from the second collimator;
a fourth port of the circulator is configured to output the optical signal inputted to the third port.

3. The optical filter system of claim 1, wherein the reflective optical filter comprises a tunable reflection device, a beam expander, a diffraction grating, and a mirror device;
the optical signal entered the tunable reflection device is reflected by the tunable reflection device to the beam expander for beam expansion, is inputted to the diffraction grating for diffraction, and is finally reflected by the mirror device;
the diffraction grating is a transmission diffraction grating which is configured to deflect different wavelengths of the transmitted optical signal at different angles, and then a part of the wavelength spectrum is reflected back along an input path through the mirror device.

4. The optical filter system of claim 1, wherein the first collimator and the second collimator are integrated into a dual-fiber collimator comprising two parallel optical fibers.

5. An optical filter system, comprising a first collimator, a second collimator and a reflective optical filter;
an optical signal being inputted through a first port of the first collimator and outputted through a second port of the first collimator, and then being filtered by the reflective optical filter, thereafter, the filtered optical signal being inputted through a second port of the second collimator and outputted through a first port of the second collimator;
an optical signal being inputted through the first port of the second collimator and outputted through the second port of the second collimator, being filtered by the reflective optical filter, thereafter, the filtered optical signal being inputted through the second port of the first collimator and outputted through the first port of the first collimator;
the optical signal outputted through the first port of the second collimator being inputted to the first port of the second collimator again.

6. The optical filter system of claim 5, wherein the optical filter system further comprises a three-port circulator;
a first port of the circulator is configured to receive an optical signal;
a second port of the circulator is connected to the first port of the first collimator, and is configured to input the optical signal received by the first port of the circulator to the first port of the first collimator and to receive the optical signal outputted by the first port of the first collimator;
a third port of the circulator is configured to output the optical signal inputted to the second port of the circulator.

7. The optical filter system of claim 5, wherein the reflective optical filter comprises a tunable reflection device, a beam expander, a diffraction grating and a mirror device;
the optical signal entered the tunable reflection device is reflected by the tunable reflection device to the beam expander for beam expansion, is inputted to the diffraction grating for diffraction, and is finally reflected by the mirror device;
the diffraction grating is a transmission diffraction grating which is configured to deflect different wavelengths of the transmitted optical signal at different angles, and then a part of the wavelength spectrum is reflected back along an input path through the mirror device.

8. The optical filter system of claim 5, wherein the first collimator and the second collimator are integrated into a dual-fiber collimator comprising two parallel optical fibers.

9. An optical filter system, comprising a first collimator, a second collimator, a third collimator and a reflective optical filter;
an optical signal being inputted through a first port of the first collimator and outputted through a second port of the first collimator, being filtered by the reflective optical filter, thereafter, the filtered optical signal passing through the third collimator, being filtered by the reflective optical filter, and then being inputted through a second port the second collimator and outputted through a first port of the second collimator.

10. The optical filter system of claim 9, wherein the third collimator comprises one collimator or multiple collimators connected in series.

11. The optical filter system of claim 9, wherein the reflective optical filter comprises a tunable reflection device, a beam expander, a diffraction grating and a mirror device;
the optical signal entered the tunable reflection device is reflected by the tunable reflection device to the beam expander for beam expansion, is inputted to the diffraction grating for diffraction, and is finally reflected by the mirror device;
the diffraction grating is a transmission diffraction grating which is configured to deflect different wavelengths of the transmitted optical signal at different angles, and then a part of the wavelength spectrum is reflected back along an input path through the mirror device.

12. The optical filter system of claim 9, wherein the first collimator and the second collimator are integrated into a dual-fiber collimator comprising two parallel optical fibers.

13. The optical filter system of claim 9, wherein the first collimator, the second collimator and the third collimator are integrated into a four-fiber collimator comprising four parallel optical fibers, and first ports of two optical fibers in the four-fiber collimator are connected together.

14. The optical filter system of claim 9, wherein the first collimator, the second collimator and the third collimator are integrated into an multi-fiber collimator having M*N parallel optical fibers, with M and N being integers greater than or equal to 2.
